(19) United States
(12) Patent Application Publication
(10) Pub. No.: US 2008/0026141 A1
(43) Pub. Date: Jan. 31, 2008

(54) Particle Filter Provided with Catalytic Coating

(75) Inventors: Marcus Pfeifer, Solingen (DE); Rainer Domesle, Alzenau-Kaelberau (DE); Nicola Soeger, Frankfurt/Main (DE); Christian Kuehn, Hasselroth (DE); Roger Staab, Freigericht (DE); Thomas Kreuzer, Karben (DE)

Correspondence Address: KALOW & SPRINGUT LLP, 488 MADISON AVENUE, 19TH FLOOR, NEW YORK, NY, 10022, US

(73) Assignee: UMICORE AG & CO. KG, HANAU-WOLFGANG (DE)

(21) Appl. No.: 11/628,657

(22) PCT Filed: Jun. 4, 2005
(86) PCT No.: PCT/EP05/06013

§ 371 Date: Aug. 29, 2007

(30) Foreign Application Priority Data
Jun. 5, 2004 (DE) 10-2004-027-591.2

(51) Int. Cl. B01D 53/94; B01J 35/00; B01J 37/02; B05D 1/12; F01N 3/28

(52) U.S. Cl. 427/201; 427/180

(57) ABSTRACT

The invention relates to particle filters having an open pore structure for separating particles from fluids, which, for modification of their properties or for treatment of the fluid to be filtered, are provided with additional metal oxides or mixed metal oxides and optionally with further catalytically active components. In particular, the invention relates to particle filters treated with a catalytically active material, which is used for the treatment of the waste gases from combustion processes, in particular for the treatment of the exhaust gases of internal combustion engines. By impregnation of the filter bodies in a solution of a metal oxide sol or a mixed metal oxide sol, the preformed sol particles are deposited on the pore surfaces. Consequently, catalytic activations of the filter with good temperature stability in combination with a moderate increase in the exhaust gas back-pressure are possible.

The invention relates to particle filters having an open pore structure for separating particles from fluids, which, for modification of their properties or for treatment of the fluid to be filtered, are provided with additional metal oxides or mixed metal oxides and optionally with further catalytically active components. In particular, the invention relates to particle filters treated with a catalytically active material, which is used for the treatment of the waste gases from combustion processes, in particular for the treatment of the exhaust gases of internal combustion engines.

In the case of the particle filters, it is possible to distinguish between deep-bed filters and surface filters. Typical deep-bed filters consist, for example, of blocks of ceramic foams having an open pore structure or of knitted wire fabrics or nonwovens. For separating off the particles contained in gases or liquids, the gases or liquids are passed through the filters. The deposition of the particles occurs in the volume of the filter bodies. In the case of surface filters, the deposition of the particles to be removed from the gases or liquids occurs substantially on the surfaces of thin-walled bodies which consist of materials likewise having an open pore structure. For filtration, the gases or liquids are passed substantially perpendicularly through the walls of these bodies. They are therefore also referred to as wall flow filters. The particles accumulate predominantly on the entry surface of the wall areas.

Wall flow filters preferably consist of ceramic materials, such as, for example, cordierite and silicon carbide. They are increasingly being used in relatively large quantities for removing soot from the exhaust gas of internal combustion engines, in particular from the exhaust gas of diesel engines. These wall flow filters preferably have the shape of a honeycomb through which parallel flow channels for the exhaust gas pass from the entry end face to the exit end face, which flow channels are mutually closed at the end faces so that, on its way from the entry end face to the exit end face, the exhaust gas is forced to pass through the porous partitions between the flow channels. By means of this design, the flow channels are distinguished as entry channels and exit channels.

With increasing loading of the filter with diesel soot, the exhaust gas back-pressure caused by it increases so that regeneration of the filter by combustion of the deposited diesel soot is necessary from time to time. The spontaneous combustion of the diesel soot begins at an exhaust gas temperature of about 600° C.

Attempts were made at an early stage to reduce the soot ignition temperature by a corresponding catalytic treatment of the filter. For example, silver vanadate (U.S. Pat. No. 4,455,393), an alkali metal perrhenate or silver perrhenate or a mixture of these substances with lithium oxide, copper(I) chloride, vanadium pentoxide with from 1 to 30% by weight of an alkali metal oxide or a vanadate of lithium, of sodium, of potassium or of cerium (U.S. Pat. No. 4,515,758) is suitable for reducing the soot ignition temperature by about 50° C. The soot ignition temperature can also be reduced by a mixture of a platinum group metal with an alkaline earth metal oxide (U.S. Pat. No. 5,100,632). Mixtures of platinum with cerium oxide, manganese oxide and calcium oxide (WO 02/26379 A1), with which a reduction of the soot ignition temperature by more than 100° C. can be achieved, are particularly suitable.

Moreover, the filter can be provided with further catalytically active components for the oxidation of carbon monoxide and hydrocarbons and for the storage of oxides of nitrogen.

In the context of the present invention, a distinction is made between coating with a suspension of pulverulent metal oxides on the one hand and coating with an impregnating solution on the other hand. When the filter is coated with a suspension of metal oxide powders, for example, the suspension is poured over the entry end face. The excess material is then removed, for example, by allowing it to run out. Thereafter, the filter is dried and is calcined for solidification of the coating. A coating having a thickness of several micrometres remains on the wall surfaces of the entry channels. Owing to the size of the powder particles, usually between 2 and 6 μm, the coating penetrates only to an insignificant extent into the pores of the filter body. The exit channels can of course be provided with such a coating in an analogous manner.

When the filter is coated by impregnation, a solution of soluble precursors of the desired metal oxides is prepared. The filter body is immersed in this solution. The solution penetrates into the pores of the filter body. By drying and calcination, the precursors of the metal oxides are converted into the desired oxides. They are then present predominantly on the internal surfaces of the filter body, which form the pores.

With the aid of suspension of metal oxides, loading concentrations up to 100 g of metal oxide per litre of filter body volume can be realized. However, a disadvantage here is that the exhaust gas back-pressure of the filter is substantially increased by the coating so that concentrations above 100 g/l are not expedient.

By means of the impregnating method, it is possible in principle to realize loading concentrations similar to those with a suspension. It is advantageous here that, with the same loading concentration, the increase of the exhaust gas back-pressure on impregnation is substantially smaller than on coating with a suspension.

U.S. Pat. No. 4,455,393 describes the coating of a wall flow filter with silver vanadate. When coating with a concentration of about 21 g/l, a reduction of the soot ignition temperature of about 50° C. is achieved, the exhaust gas back-pressure increasing by about 50% owing to the coating. U.S. Pat. No. 5,100,632 describes the impregnation of a wall flow filter with aqueous solutions of platinum group metal salts and alkaline earth metal salts. For example, a loading concentration of 7 g of magnesium oxide per litre of filter body is achieved therewith.

On regeneration of a diesel soot filter by combustion of the soot, high temperatures which may damage the catalytic components also occur with the use of catalytic components lowering the ignition temperature of the filter. The damage consists primarily in a reduction of the specific surface area of the components.

It is known that the temperature stability of the specific surface area of metal oxides can be increased, for example, by doping with alkaline earth metals and/or rare earth metals or by formation of mixed oxides. Thus, a mixed oxide comprising cerium oxide and zirconium oxide is substantially more stable to thermal loads than pure cerium oxide. Such mixed oxides and stabilized materials are commercially available. However, as described above, they must be applied to the geometric surface of the channel walls of the filter with the use of a suspension, which is associated with a correspondingly high exhaust gas back-pressure.

The attempt to introduce such metal oxides into the particle filter with the aid of the impregnating technique using an impregnating solution containing soluble compounds of cerium and of zirconium leads, in the experience of the inventors, to a lower temperature stability. Evidently, the desired, temperature-stable cerium/zirconium mixed oxides are not formed to a sufficient extent during the calcination following the impregnation.

If, therefore, the coating of a particle filter is applied by using a suspension of preformed powder materials, this coating has the good temperature stability of these powder materials. A disadvantage here is the associated high exhaust gas back-pressure. By applying the coating by impregnation of the particle filter with a solution of precursors of the desired coating materials, the exhaust gas back-pressure can be reduced, which however is achieved at the expense of the achievable temperature stability since the actual coating material is only formed on the particle filter by calcination. The degrees of freedom available in the case of the separate preparation of powder materials are of course not available here.

The present invention is intended to remedy this dilemma and to provide a coated particle filter which, on the one hand, has a lower exhaust gas back-pressure than a filter coated with conventional powder materials and whose coating on the other hand has a higher temperature stability than is achievable by the impregnation technique.

This object is achieved by a particle filter having an open pore structure for the filtration of particles from the exhaust gas stream of an internal combustion engine, in which filter colloidal metal oxides or mixed metal oxides having particle sizes of less than 1 μm are deposited on all surfaces accessible to the exhaust gas stream.

In the context of this invention, the formulation “all surfaces accessible to the exhaust gas stream” designates both the surfaces of those pores which come into contact with the exhaust gas owing to the open pore structure and the external, geometric surface of the filter body.

According to the invention, neither are the desired metal oxides or mixed metal oxides present as a coating of powder materials on the external, geometric surface of the particles nor are the oxides introduced into the pores of the filter by impregnation with soluble precursors of the oxides with subsequent drying and calcination. Rather, preformed sols of the metal oxides or sols of the mixed oxides are used for depositing the metal oxides on all surfaces accessible to the exhaust gas (internal and external surfaces). These sols have particle sizes of less than 1 μm. Preferably, the particle sizes of these materials are between 1 and 500 nm. Owing to their particle size, these materials form a substantially homogeneous, clear solution after dispersing, for example in water. The term colloidal solution, or sol, is therefore used. When a light beam is shone through this solution, the path of the light through the solution can be observed when viewed laterally, since the light is scattered in all directions by the particles present in the solution (Tyndall effect).

The sol particles are preformed, i.e. they already have their final shape and chemical composition. These properties change only insignificantly as a result of the thermal treatment after loading of the filter. In contrast, in the case of conventional impregnation methods using a solution of precursors of the subsequent metal oxides, the metal oxide particles are formed in a more or less random manner only as a result of drying and calcination. The particles forming hereby are of nonuniform surface and structure, which, in contrast to the sol, depends to a great extent on the individual production conditions.

For the particle filter according to the invention, metal oxides are preferably selected from the group of oxides of the metals consisting of aluminium, silicon, titanium, cerium, zirconium, hafnium, magnesium, iron and mixed oxides thereof. If a filter having a reduced ignition temperature for soot is desired, a cerium/zirconium oxide sol is preferably chosen.

Sols of these materials are commercially available with different particle sizes as solid powder or as solutions. Typical aluminium oxide sols have, as powder material, mean particle sizes between 10 and about 50 μm. After dispersing in water, the dispersed sol particles have diameters between 10 and 500 nm.

A substantial advantage of the sols is that catalytically active substances, such as, for example, the platinum group metals platinum, palladium or rhodium, can be deposited in the form of their salts on the oxide sol or applied together therewith. After application of the oxide sol treated in this manner to the filter, the noble metal particles are present on the surface of the sol particles and can readily display their action there, namely the chemical conversion of the gaseous pollutant components. Furthermore, it is ensured that the noble metal is present exclusively on the desired carrier material and not on the filter body. If, on the other hand, in the conventional impregnation method, a noble metal salt is mixed with a solution of precursors of the metal oxide or mixed oxide, the noble metal compound crystallizes out together with the metal oxide and is partly enclosed or buried in the subsequent calcination.

The particular advantages of the invention are evident if a doped metal oxide or a mixed oxide, such as, for example, a mixed cerium/zirconium oxide, is to be applied to the filter. According to the prior art, the filter body is for this purpose impregnated with a common solution of cerium nitrate and zirconyl acetate and then dried and calcined. A mixture which has a large surface area and comprises cerium oxide and zirconium oxide results thereby, but not the desired mixed oxide. The material is therefore not stable to thermal loads. On the other hand, sols of the desired mixed oxides are preformed and are extremely temperature-stable. They maintain their specific surface area even under high thermal loads and thus lead to extremely temperature-stable, catalytically activated filter bodies. Moreover, filter bodies treated in this manner exhibit only a small increase in the exhaust gas back-pressure.

The particle filter may be present as a deep-bed filter or wall flow filter. Deep-bed filters may consist of a knitted wire fabric, of a ceramic fibre felt or of a sintered metal or of a ceramic foam. Wall flow filters, on the other hand, are produced from cordierite or silicon carbide. The wall flow filter already described in the prior art are preferably used. They consist of cordierite, silicon carbide or other ceramic materials or components and have a porosity of from 30 to 90% with mean pore diameters between 10 and 50 μm. Their porosity is preferably between 45 and 90%.

For the deposition of the sol particles on the surfaces of the filter which are accessible to the exhaust gas, an aqueous or organic solution of the sol is prepared. The filter is then impregnated with this solution, for example by immersion, and, after removal of excess solution, is dried and is calcined at from 300 to 600° C. This process is optionally repeated several times in order to obtain a loading concentration between 5 and 100, preferably from 10 to 80, g per litre of the filter body.

The catalytic activation of the filter with, for example, the noble metals of the platinum group can take place as described above by using sols which have already been catalytically activated. Alternatively, the activation can also be carried out after the application of the sol particles by subsequent impregnation, drying and calcination with corresponding precursors of the noble metals. Independently of the method used, the filter is preferably activated with platinum in a concentration of from 0.1 to 5 g of noble metal per litre of the catalyst body.

1. Particle filter having an open pore structure for the filtration of particles from the exhaust gas stream of an internal combustion engine, characterized in that colloidal metal oxides or mixed metal oxides having particle sizes of less than 1 μm are deposited on all surfaces accessible to the exhaust gas stream.

2. Particle filter according to claim 1, characterized in that the metal oxides are selected from the group of oxides of the metals consisting of aluminium, silicon, titanium, cerium, zirconium, hafnium, magnesium, iron and mixed oxides thereof.

3. Particle filter according to claim 2, characterized in that the filter is present in the form of a deep-bed filter or as a wall flow filter.

4. Particle filter according to claim 3, characterized in that the filter consists of a knitted wire fabric, of a ceramic fibre felt, or of a sintered metal or of a ceramic foam.

5. Particle filter according to claim 3, characterized in that the filter is present in the form of a wall flow filter and consists of cordierite or silicon carbide.

6. Particle filter according to claim 4, characterized in that a mixed cerium/zirconium oxide sol is deposited on all surfaces accessible to the exhaust gas stream.

7. Particle filter according to claim 1, characterized in that the colloidal metal oxides or mixed metal oxides are catalytically activated with noble metals of the platinum group.

8. Particle filter according to claim 7, characterized in that the colloidal metal oxides or mixed metal oxides have mean particle sizes between 1 and 500 nm.

9. Particle filter according to claim 1, characterized in that the filter has a porosity of from 30 to 90% with mean pore diameters between 10 and 50 μm.

10. Particle filter according to claim 9, characterized in that the filter has a porosity of from 45 to 90%.

11. Particle filter according to claim 1, characterized in that the concentration of the colloidal metal oxides or mixed metal oxides on the filter is between 5 and 100 g per litre of the filter body.

12. Particle filter according to claim 11, characterized in that platinum in a concentration of from 0.1 to 5 g per litre of the filter body is present as a noble metal of the platinum group.

13. Use of the particle filter according to claim 1 for the removal of soot from the exhaust gas of internal combustion engines operated completely or predominantly with a lean mixture.

14. Process for the production of the particle filter according to claim 1 by impregnation of the filter in an aqueous solution or suspension of the colloidal metal oxide or mixed metal oxide, subsequent drying and optionally calcination at temperatures between 300 and 600° C.
